(19) United States
(12) Patent Application Publication
(10) Pub. No.: US 2008/0126588 A1
(43) Pub. Date: May 29, 2008

(54) MEMORY CARD

(75) Inventor: Hon Wai Chong, Kowloon (HK)

Correspondence Address: LAWRENCE Y.D. HO & ASSOCIATES PTE LTD, 30 BIDEFORD ROAD, #02-02, THONGSIA BUILDING, SINGAPORE, 229922, omitted

(73) Assignee: Orion Micro Design (S) Pte Ltd, Chinatown Point (SG)

(21) Appl. No.: 11/469,488

(22) Filed: Sep. 1, 2006

(51) Int. Cl. G06F 3/00; G06F 1/12

(52) U.S. Cl. 710/13; 710/61

(57) ABSTRACT

The present invention provides a memory card for use with an electronic device. The memory card comprises an input/output (I/O) interface for coupling the memory card to the electronic device and a card controller electrically coupled to the I/O interface. In particular, the card controller comprises a plurality of engines configured to operate in different formats. The card controller further comprises a means for detecting the format of the electronic device and generating a response signal containing the format of the electronic device. A micro-controller is electrically coupled to the plurality of engines, wherein the micro-controller activates an appropriate engine from the plurality of engines to transfer data based on the response signal. Furthermore, the memory comprises a memory module electrically coupled to the plurality of engines for storing data. One advantage of the memory card is that it enables a user to store and transfer data in various formats.

### FIELD OF THE INVENTION

The present invention generally relates to memory cards for data storage, and more particularly to a memory card enabling a user to store and transfer data in various formats.

### BACKGROUND OF THE INVENTION

Non-volatile storage devices such as memory cards have become increasingly popular because they are compact in size, have large storage capacities, and are compatible with different electronic devices such as personal computers (PCs) and personal digital assistants (PDAs). Some well-known memory cards are the MultiMediaCard (MMC), the Secure Digital (SD) memory card, and the Memory Stick (MS) memory card.

Besides being a storage device, a memory card serves as a means for transferring data between different electronic devices. The memory card provides high-speed reading and writing of data to an internal memory, where the internal memory is volatile solid-state memory that serves as the storage medium. For example, a high-speed memory card can provide a data transfer rate of up to 100 Mbps depending on its operating mode. In an age where data is stored and transferred in large volumes, the advantage of high-speed data transfers contributes significantly to the popularity of the memory card. However, one of the constraints faced by consumers is that different memory cards have different interfaces and communication protocols, which makes it difficult for the consumers to transfer data between the different types of memory cards and the desired electronic devices. For example, an electronic device such as a digital camera is usually designed with a particular memory card interface and communication protocol. If the digital camera uses a MS memory card interface and communication protocol, then other types of memory cards such as MMC and SD would not be able to transfer data to or from the digital camera.

A universal memory card reader is typically used to transfer data between a PC and various types of memory cards. The card reader is coupled to PC via a USB cable, and has a plurality of slots to interface with various types of memory cards such as MMC, SD, MS, etc. The card reader can be an internal or external component of the PC. Although the card reader provides a standard interface for various types of memory cards, it has certain drawbacks. For example, the universal USB reader is restricted to data transfer between memory cards and the PC. Other electronic devices, such as digital cameras, are not able to utilize the potential of the universal USB reader. Furthermore, there might be misinterpretation of information when data is transferred from the memory cards to the PC via the card reader.

Therefore, there is an imperative need to have a memory card that enables a user to store and transfer data in various formats. The memory card can be adapted to interface with different electronic devices, thereby obviating the need for a card reader. Other advantages of this invention will be apparent with reference to the detailed description.

### SUMMARY OF THE INVENTION

The present invention provides a memory card that enables a user to store and transfer data in various formats.

Accordingly, in one aspect, the present invention provides a memory card for use with an electronic device, the memory card comprising: an input/output (I/O) interface for coupling the memory card to the electronic device; a card controller electrically coupled to the I/O interface, the card controller comprising: a plurality of engines configured to operate in different formats; format detecting means for detecting the format of the electronic device and generating a response signal indicating the format of the electronic device; and a micro-controller electrically coupled to the plurality of engines and the format detecting means, wherein when the micro-controller receives the response signal, it activates an appropriate engine from the plurality of engines to transfer data based on the response signal; and a memory module electrically coupled to the plurality of engines for storing data.

### BRIEF DESCRIPTION OF THE DRAWINGS

Preferred embodiments according to the present invention will now be described with reference to the Figures, in which like reference numerals denote like elements.

FIG. 1 is a block diagram of the Super Storage Compact (SSC) memory card in accordance with one embodiment of the present invention.

FIG. 2 is a circuit block diagram of the SSC card controller in accordance with one embodiment of the present invention.

FIG. 3 is the block diagram of the SSC Engine in accordance with one embodiment of the present invention.

FIG. 4 is the block diagram of the half frequency data clocked engine in FIG. 3.

FIG. 5 is the block diagram of the data storage engine in FIG. 4.

FIG. 6 is an illustrative diagram showing the conversion of data by the data multiplexer engine in FIG. 4.

FIG. 7 is a flow chart of the data flow when data is transferred from an electronic device to the SSC memory card.

FIG. 8 is a flow chart of the data flow when the data is transferred from the SSC memory card to an electronic device.

FIG. 9 is an illustrative diagram of the SSC command protocol in accordance with one embodiment of the present invention.

FIG. 10 is an illustrative diagram of the SSC-1 data protocol in accordance with one embodiment of the present invention.

FIG. 11 is an illustrative diagram of the SSC-4 data protocol in accordance with one embodiment of the present invention.

FIG. 12 is an illustrative diagram of the SSC-8 data protocol in accordance with one embodiment of the present invention.

FIG. 13 is an illustrative diagram of the SSC-8 data protocol using the half frequency data clock engine.

FIG. 14 is an illustrative diagram of the data capture using two internal clocks by the SSC memory card.

### DETAILED DESCRIPTION OF THE INVENTION

The present invention may be understood more readily by reference to the following detailed description of certain embodiments of the invention.

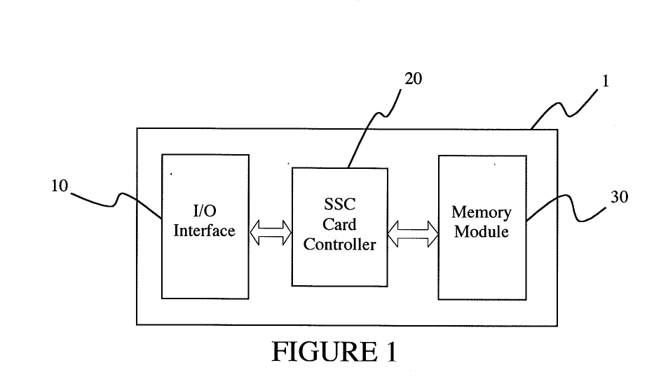

The present invention provides a memory card that enables a user to store and transfer data in various formats or protocols such as MultiMediaCard (MMC), Secure Digital (SD), and Memory Stick (MS). FIG. 1 shows a block diagram of the memory card, referred hereinafter as the Super Storage Compact (SSC) memory card 1. The SSC memory card 1 comprises an input/output (I/O) interface 10, a SSC card controller 20, and a memory module 30. The I/O interface 10 is electrically coupled to the SSC card controller 20 and serves as a mechanical interface between the memory card 1 and a host or electronic device (not shown). The electronic device can be a mobile phone, a digital camera, a personal digital assistants (PDA), or any other devices that requires a memory card. The SSC card controller 20 is electrically coupled to the memory module 30, wherein the memory module 30 comprises a plurality of NAND Flash memory chips for storing data. It is also contemplated that the memory module 30 can be composed of other types of memory chips.

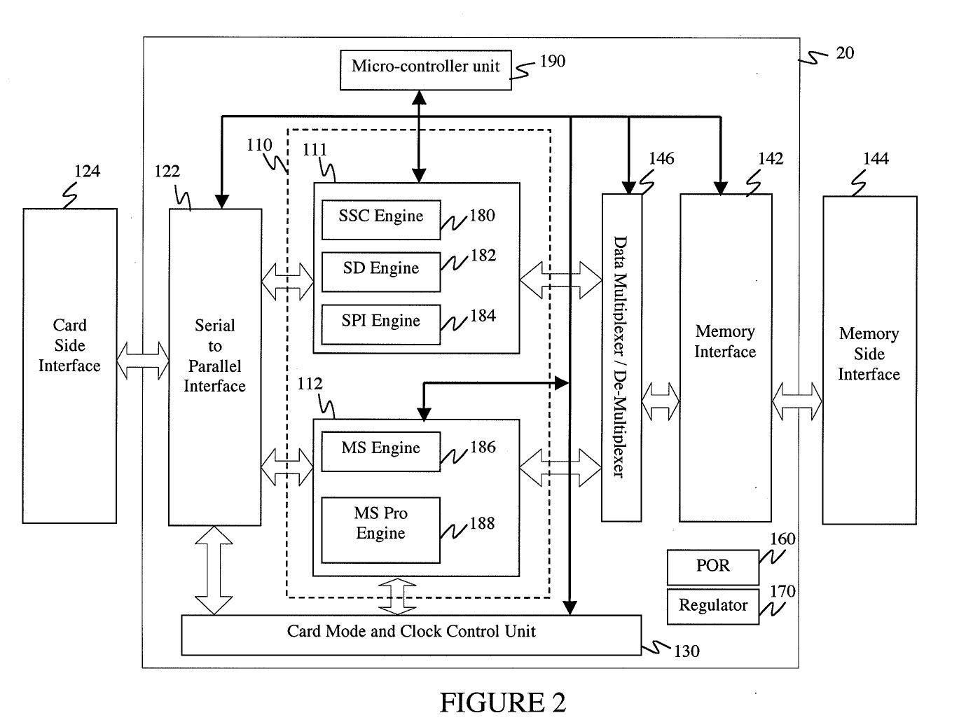

FIG. 2 illustrates the circuit block diagram of the SSC card controller 20 comprising a plurality of controllers 110, a serial to parallel interface 122, a card-side interface 124, a card mode and clock control unit 130, a memory interface 142, a memory-side interface 144, and a micro-controller unit (MCU) 190. The plurality of controllers 110 comprise a first controller 111 and a second controller 112, wherein the first controller 111 is configured to operate in SSC, SD, and SPI modes/formats and the second controller 112 is configured to operate in MS and MS Pro modes/formats. It is contemplated that the plurality of controllers 110 are not limited to operating in SSC, SD, SPI, MS and MS Pro modes/formats but may also be configured to operate in other forms of card modes/formats.

Specifically, the first controller 111 comprises a SSC engine 180, a SD engine 182 and a SPI engine 184, wherein the SSC engine 180 supports the SSC-1, SSC-4 and SSC-8 communication protocols, the SD engine 182 supports the SD-1, SD-4 and SPI communication protocols, and the SPI engine 184 supports the SPI communication protocol. For the first controller 111, the SSC engine 180, SD engine 182 and SPI engine 184 have similar communication protocols which are illustrated in Table 1 below. Hence, the SSC engine 180, SD engine 182 and SPI engine 184 can be designed to share the same physical resources in order to reduce the chip size of the first controller 111.

The second controller 112 comprises a MS engine 186 and a MS Pro engine 188, wherein the MS engine 186 supports the MS communication protocol, and the MS Pro engine 188 supports the MS Pro communication protocol. Table 2 illustrates the similar communication protocols for the MS engine 186 and MS Pro engine 188. Hence, the MS engine 186 and MS Pro engine 188 are designed to share the same physical resources in order to reduce the chip size of the second controller 112.

TABLE 1
Communication protocols for the first controller

| | SPI Engine | SD Engine | SSC Engine |
|---|---|---|---|
| SPI Mode | ✓ | ✓ | ✓ |
| SD1/SSC1 Mode | | ✓ | ✓ |
| SD4/SSC4 Mode | | ✓ | ✓ |
| SSC Mode | | | ✓ |

TABLE 2
Communication protocol for the second controller

| | MS Engine | MS PRO Engine |
|---|---|---|
| MS Mode | ✓ | ✓ |
| MS PRO Mode | | ✓ |

The plurality of controllers 110 are electrically coupled to the serial to parallel interface 122, wherein the serial to parallel interface 122 is electrically coupled to the card-side interface 124. The card-side interface 124 serves as a mechanical connection between the I/O interface 10 and the SSC card controller 20. Furthermore, the serial to parallel interface 122 is provided to convert serial data format from the card-side interface 124 to parallel data format for processing by the plurality of controllers 110.

The plurality of controllers 110 are electrically coupled to the memory interface 142 via a data multiplexer/de-multiplexer 146, wherein the memory interface 142 is electrically coupled to the memory-side interface 144. The memory-side interface 144 serves as a mechanical connection between the SSC card controller 20 and the memory module 30. The memory interface 142 can be configured to read the information of the memory module 30 such as ID and manufacture information, and transmit the information to the MCU 190. The MCU 190 can be a DP8051 CPU Core. The firmware of the MCU 190 then configures the memory interface 142 to match the different memory module 30, thus allowing the memory interface 142 to be adaptable to different types of memory module 30.

The card mode and clock control unit 130 is electrically coupled to the plurality of controllers 110 and the serial to parallel interface 122. The card mode and clock control unit 130 is configured to detect the format (SPI, SD, SSC, MS, or MS Pro) of the electronic device. When the SSC memory card 1 is coupled to the electronic device, the electronic device transmits a command signal to the SSC controller 20. In particular, the command signal is transmitted to the serial to parallel interface 122, and the card mode and clock control unit 130 detects the command signal from the serial to parallel interface 122. Then, the card mode and clock control unit 130 processes the command signal and transmits a response signal containing the format of the electronic to the MCU 190.

The MCU 190 is electrically coupled to the serial to parallel interface 122, the first controller 111, the second controller 112, the card mode and clock control unit 130, the data multiplexer/de-multiplexer 146 and the memory interface 142. As discussed above, the card mode and clock control unit 130 transmits a response signal containing the format of the electronic device to the MCU 190. Based on the response signal, the firmware in the MCU 190 activates the appropriate engine to transfer data between the SSC memory card 1 and the electronic device. Supposed the card mode and clock control unit 130 detects a SD format from the electronic device, the MCU 190 will activate the SD engine 182 to transfer data between the electronic device and the SSC memory card 1. Furthermore, the MCU 190 detects and processes the command signal of the electronic device from the serial to parallel interface 122. Depending on the type of command signal received from the electronic device, the MCU 190 controls the SD engine 182 to either transfer data from the electronic device to the memory module 30, or transfer data from the memory module 30 to the electronic device. Furthermore, the MCU 190 deactivates the remaining engines when the SD engine 182 is in operation. In addition, the card mode and clock control unit 130 deactivates the remaining engines clock signal, and only activates the clock signal of the SD engine 182. As a result, the remaining engines will be in a power down mode so as to reduce the current consumption of the SSC card controller 20.

In addition, the SSC card controller 20 comprises a power on reset (POR) unit 160 and a regulator unit 170. The POR unit 160 is provided for resetting the internal circuitry of the SSC card controller 20 when the SSC memory card 1 is first inserted into an electronic device. The regulator 170 serves as a means for converting supply voltage from 3.3 V to 1.8 V for use by the internal circuitry of the SSC card controller 20.

When the SSC memory card 1 is coupled to an electronic device, data from the electronic device is transferred to the SSC memory card 1 via the I/O interface 10, wherein the data is being processed by the SSC card controller 20 and then stored in the memory module 30. Also, data originally stored in the memory module 30 can be transferred to the internal memory of the electronic device.

As discussed above, the MCU 190 determines the operating mode of the SSC memory card 1 based on the format detected by the card mode and clock control unit 130. The MCU 190 then controls the SSC card controller 20 to operate either in SSC, SPI, SD, MS, or MS Pro modes. The SPI, SD, MS and MS Pro operating modes are well known in the field and will not be discussed herein.

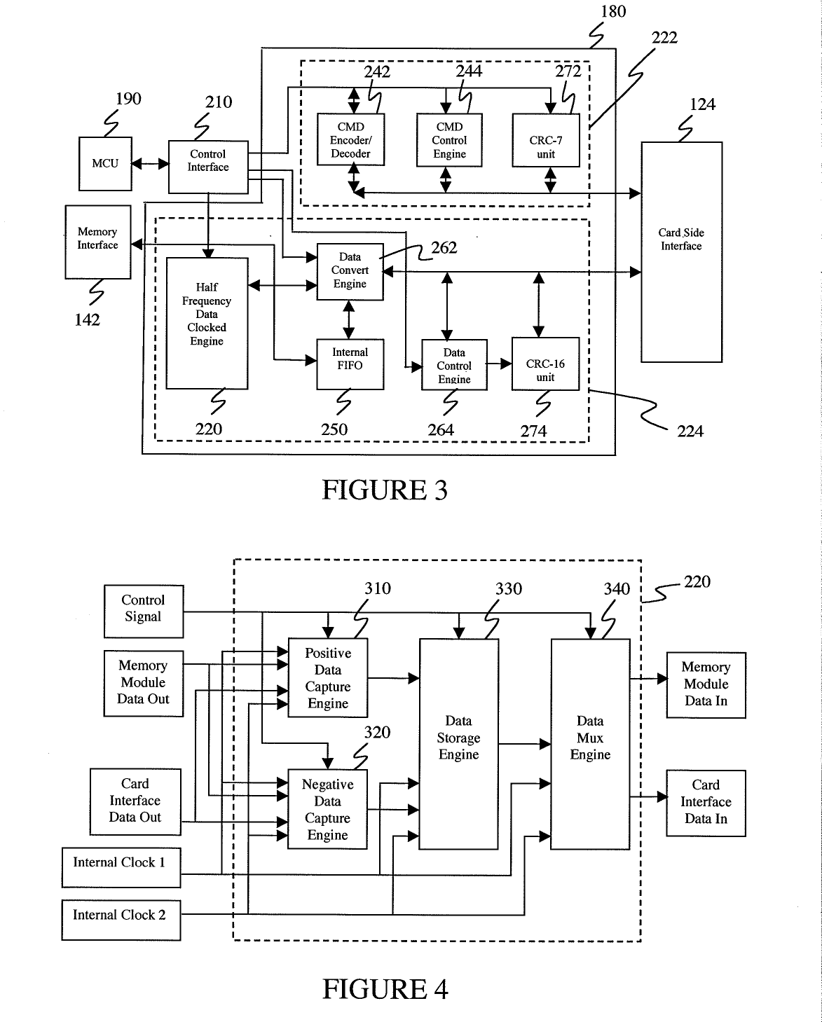

FIG. 3 shows the SSC engine 180 comprising a command module 222 and data transfer module 224. The command module 222 is configured to transmit a command packet to the electronic device or receive a command packet from the electronic device. In particular, the command module 222 comprises a command (CMD) encoder/decoder 242, a CMD control engine 244, and a 7-bit cyclic redundancy check unit (CRC-7) 272. The data transfer module 224 comprises a half frequency data clocked engine 220, an internal FIFO or buffer 250, a data convert engine 262, a data control engine 264, and a 16-bit cyclic redundancy check unit (CRC-16) 274. The CRC-7 unit 272 and the CRC-16 unit 274 are well known in the field and will not be described in detail herein.

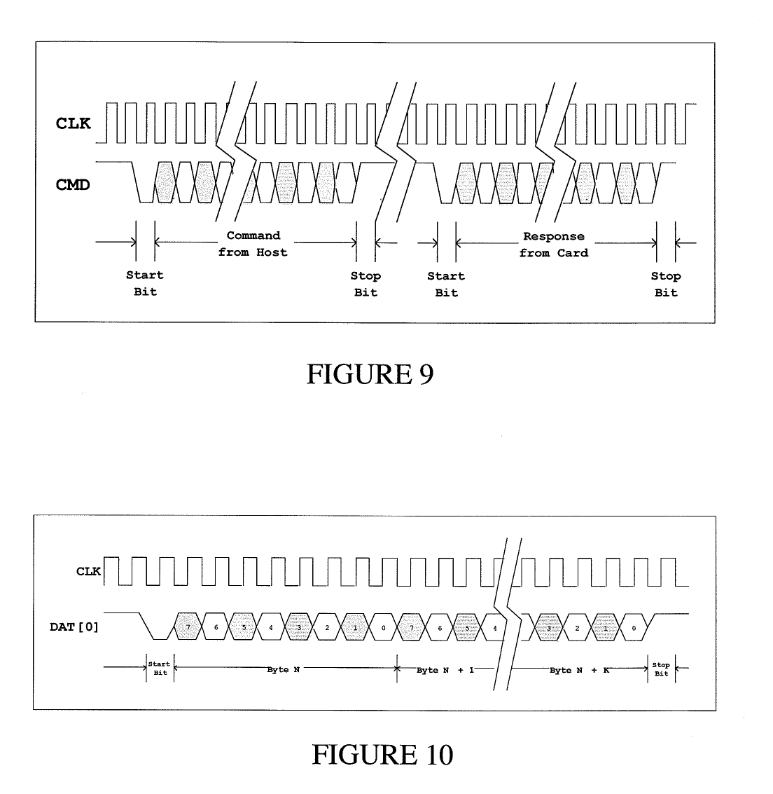

Generally, a control interface 210 couples the MCU 190 to the plurality of controllers 110. In FIG. 3, the control interface 210 is coupled to the CMD encoder/decoder 242 of the SSC engine 180. Depending on the type of signals received from the MCU 190, the control interface 210 generates control signals for the plurality of controllers 110 during command and data protocols. FIG. 9 illustrates one example of the command protocol, wherein the host or electronic device first transmits a command signal to the SSC memory card 1. Then, the MCU 190 of the SSC memory card 1 processes the command signal from the host and sends a response signal to the host. The control interface 210 is configured to control the command flow and data flow of the internal circuitry in the SSC card controller 20 to ensure that the correct format of data packet and command packet is either transmitted to or received from the card-side interface 124.

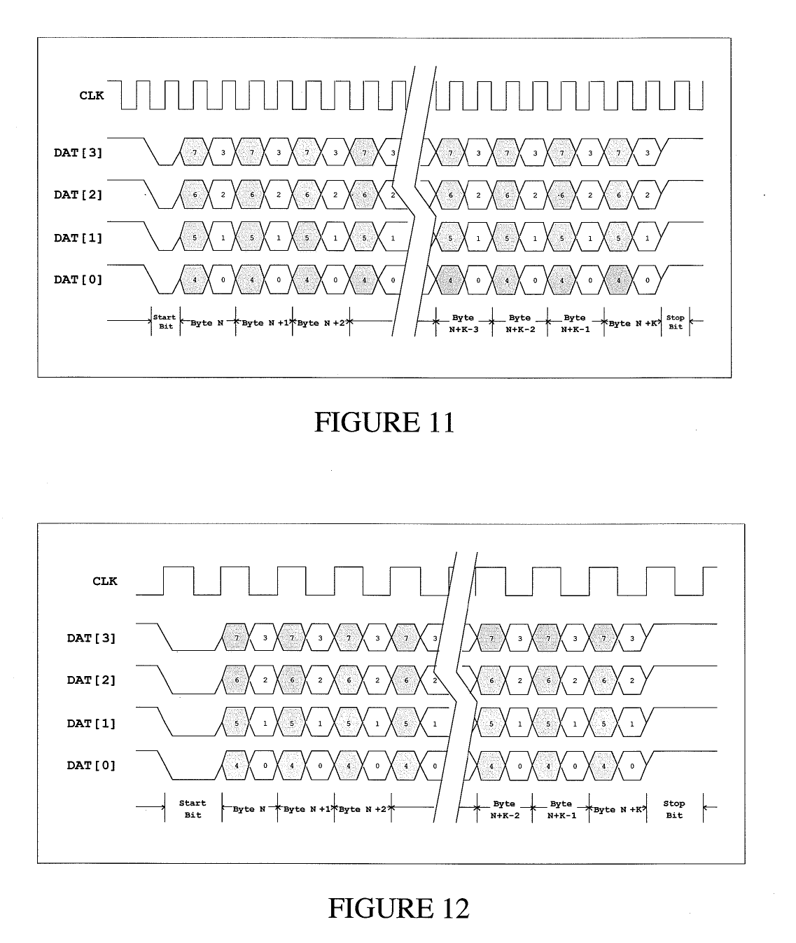

In the command module 222, the CMD encoder/decoder 242 encodes the command signal into a command packet that is to be transmitted to the card-side interface 124. Furthermore, the CMD encoder/decoder 242 generates control signals to activate the SSC data protocol SSC-1, SSC-4, or SSC-8. Specifically, the CMD encoder/decoder 242 decodes the command content of the command packet that is received from the card-side interface 124, and checks the command content integrity using the CRC-7 unit 272. Then, the CMD encoder/decoder 242 sends a signal to the control interface 210 to generate the control signal to obtain the correct command content from card-side interface 124. Thereafter, the CMD encoder/decoder 242 generates control signals to activate the SSC data protocol SSC-1, SSC-4, or SSC-8. FIGS. 10-12 illustrate the SSC-1, SSC-4 and SSC-8 communication protocols respectively. In particular, the SSC-1 data protocol as shown in FIG. 10 comprises one data line. FIG. 11 shows the SSC-4 data protocol comprising four data lines, where each bit of information in a data line is released or captured at the falling edges of the system clock in the SSC memory card 1. The system clock is referenced as CLK. Furthermore, FIG. 12 shows the SSC-8 data protocol, where each bit of information in a data line is released or captured at the falling and rising edges of the system clock. The SSC-8 data protocol allows faster data transfer between the SSC memory card 1 and other electronic devices.

Referring back to FIG. 3, the CMD encoder/decoder 242 is coupled to the CMD control engine 244, wherein the CMD control engine 244 controls the format of the command packet. The CRC-7 unit 272 is coupled to the CMD control engine 244, wherein the CRC-7 unit 272 is used to protect content of the command packet in order for the SSC engine 180 to receive or transmit the command packet correctly. Depending on the type of command packet received from the electronic device via the card side interface 124, the MCU 190 controls the data transfer module 224 of the SSC engine 180 to transfer data between the memory module 30 and the electronic device.

In the data transfer module 224, the data convert engine 262 is configured to convert the parallel data format from the internal FIFO 250 to serial data format for the card-side interface 124. Furthermore, the data convert engine 262 also converts the serial data format from the card-side interface 124 to parallel data format for the internal FIFO 250. The internal FIFO 250 serves as a buffer that stores the data from the data convert 262 temporarily for internal data processing. The data control engine 264 is coupled to the control interface 120 and CMD control engine 244, wherein the data control engine 264 controls the format of the data packet. The CRC-16 unit 274 is coupled to the data control engine 264, wherein the CRC-16 unit 274 is used to check the integrity of the data packet in order to ensure that the SSC engine 180 receives the data packet correctly. Furthermore, the CRC-16 unit 274 is used to add the integrity of the data packet in order to ensure that the SSC engine 180 transmits the data packet correctly.

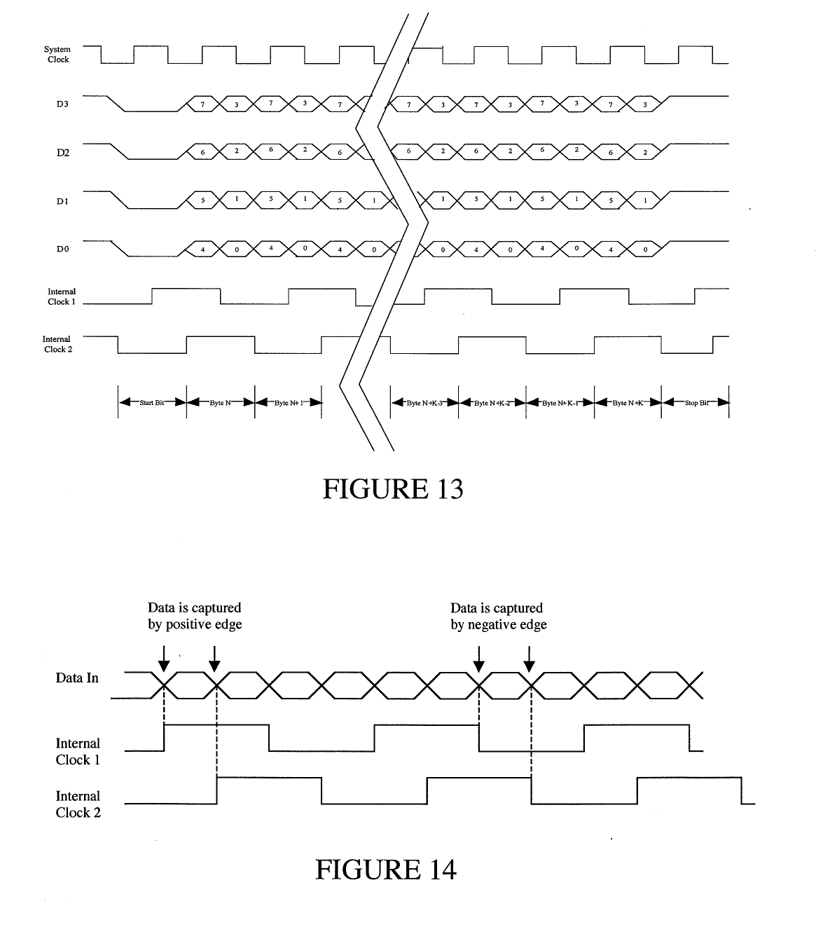

The half frequency data clocked engine 220 is provided to facilitate the SSC engine 180 to operate in the SSC-8 data protocol. FIG. 4 shows the block diagram of the half frequency data clocked engine 220, comprising a positive data capture engine 310, a negative data capture engine 320, a data storage engine 330, and a data multiplexer engine 340. The system clock of the SSC memory card 1 is configured to run at two internal clocks, wherein each internal clock is half the frequency of the system clock. Referring to FIG. 13, supposed the system clock is designed at 80 MHz, the two internal clocks referenced as internal clock 1 and internal clock 2 will be operating at 40 MHz. Furthermore, the internal clock 2 is configured to operate at half-period delay relative to the internal clock 1. The data input to the half frequency data clocked engine 220 comes from either the data output from the memory module 30 or the card-side interface 124. The data input is then transmitted to the positive data capture engine 310 or the negative data capture engine 320. Referring to FIG. 14, data can be captured at the positive and negative edges of the two internal clocks. The positive data capture engine 310 captures data at the rising or positive edges of both internal clocks 1 and 2. The negative data capture engine 320 captures data at the falling or negative edges of both internal clocks 1 and 2. The data captured is then stored in the data storage engine 330.

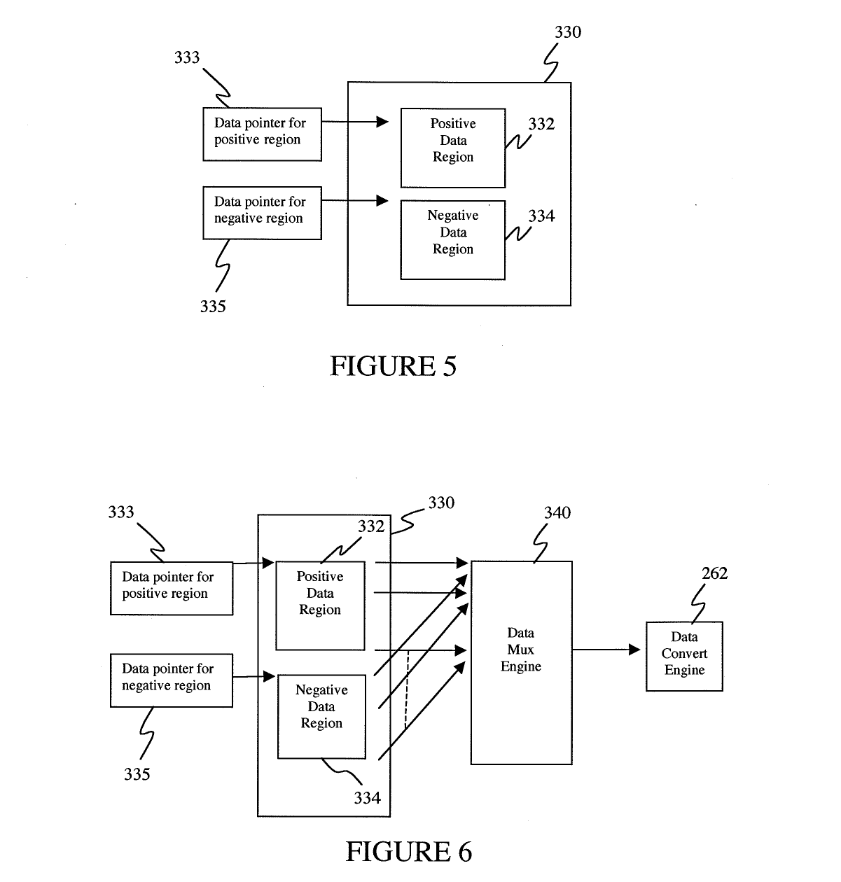

The data storage engine 330 as shown in FIG. 5 is partitioned into two regions, the positive data region 332 and the negative data region 334. The positive data region 332 stores the data captured by the positive data capture engine 310, and the negative data region 334 stores the data captured by the negative data capture engine 320. Furthermore, the data storage engine 330 comprises two data pointers for locating the data stored in order to avoid data confusion. A first data pointer 333 locates the data stored in the positive data region 332 and a second data pointer 335 locates data stored in the negative data region 334. The captured data is packed in the data storage engine 330 before it is transmitted to the data multiplexer engine 340. In particular, the data is stored in positive data region 332 and the negative data region 334 in a 4-bit serial format. Before storing the data into the memory module 30, the data stored in the positive data region 332 and the negative data region 334 is combined into an 8-bit serial format. Referring to FIG. 6, the data multiplexer engine 340 selects the data stored in the positive data region 332 and the negative data region 334 and converts the data into the 8-bit serial format. The converted 8-bit data is then stored in the internal FIFO 250 before transferring to the memory module 30.

One advantage using the half frequency data clocked engine 220 is the reduction in gate count. In a preferred embodiment, the positive data capture engine 310 and the negative data capture engine 320 are designed with synchronous circuit. The data multiplexer engine 340 is designed with combination circuit. Furthermore, the data storage engine 330 is designed with equal proportions of synchronous and combination circuits. In this case, the half frequency data clocked engine 220 will have a reduced gate count of 20% compared to another design of the half frequency data clocked engine that uses synchronous circuit only.

Another advantage of using the half frequency data clocked engine 220 is the reduction in power. CMOS power consumption is governed by the equation:

Power=K*F_{c}*C*V_{dd}² Eqn (1)

Where K=Switching Factor, F_{c}=Operating Frequency, C=Load being Switched, and V_{dd}=Operating Voltage.

The switching factor (K), or how often the output of a cell switches relative to the frequency of operation, is a highly design-dependent parameter on process. Standard cell library contain power consumption information on a per-cell basis.

The operating frequency (F_{c}) of a design directly affects its power consumption, wherein designs that operate at a higher frequency have higher power consumption. The operating frequency (F_{c}) of a design is generally governed by its logic design. As such, the amount of power strapping used within a design will depend on the operating frequency (F_{c}).

The parameter Load being Switched (C) is equivalent to the total gate count capacitive loading on the output pin, including the capacitance of each input pin connected to the output driver, and the route wire capacitance (actual or estimated (pF)). The Load being Switched is directly proportional to Total Gate Count.

Since the Operating Voltage (V_{dd}) is fixed and the Switching Factor (K) is normally at 20%, the only variables are Load Being Switched (C) and Operating Frequency (F_{c}). Therefore, power is now represented by Equation (2) as:

Power∝(Load being Switched)∝(Operating Frequency) Eqn (2)

As discussed above, the gate count is reduced by 20%. So, the load being switched is also reduced by 20%. Furthermore, the operating frequency is reduced by 50% because the two internal clocks are operating at half the system clock frequency. Therefore, the power is reduced by more than 70%.

Yet another advantage of the half frequency data clocked engine 220 is that it can be implemented with a high performance RISC CPU Core as the MCU 190. Some exampled of the high performance RISC CPU Core is the ARM Core (ARM946E-S) and the PowerPC Core (PowerPC 440). Generally, the high performance RISC CPU Core captures data during positive edge and negative edge of the clock cycle. In the SSC card controller 20, the data is released at the positive level and negative level of the clock cycle. Therefore, the high performance RISC CPU Core directly captures data without encountering any setup time and hold time problems.

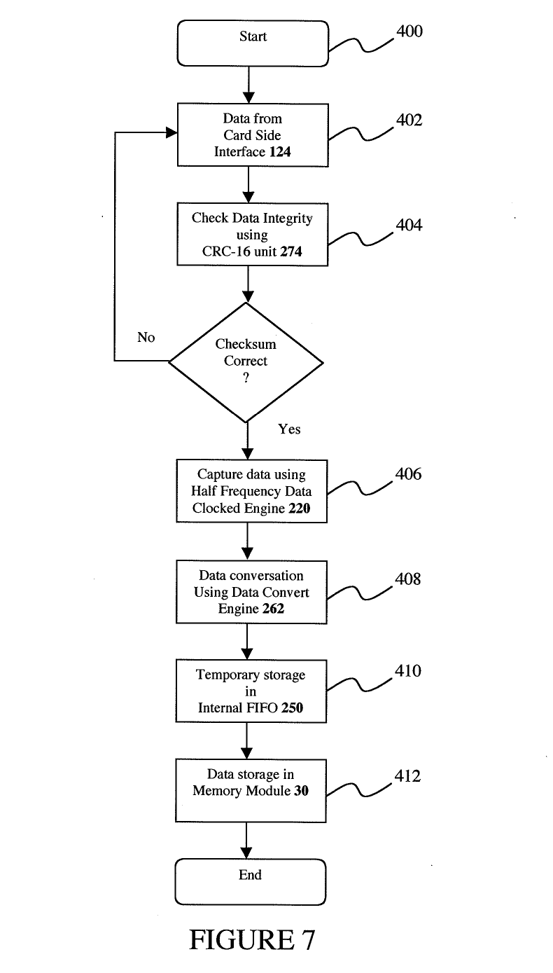

FIG. 7 illustrates the flow chart of the data flow when data is transferred from an electronic device to the SSC memory card 1. At the start 400 of the data flow, the data from the electronic device is first transferred to the card-side interface 124 in step 402. The CRC-16 unit 274 then checks the integrity of the data received from the card-side interface 124 in step 404. If the check sum of the CRC-16 unit 274 is incorrect, the data flow returns to step 402. However, if the check sum is correct, the half frequency data clocked engine 220 will proceed to capture the data in step 406. The data captured in step 406 is then converted by the data convert engine 262 in step 408. Furthermore, the converted data from step 408 is temporarily stored in the internal FIFO 250 in step 410. Finally, the data from step 410 is transferred to the memory module 30 for storage in step 412.

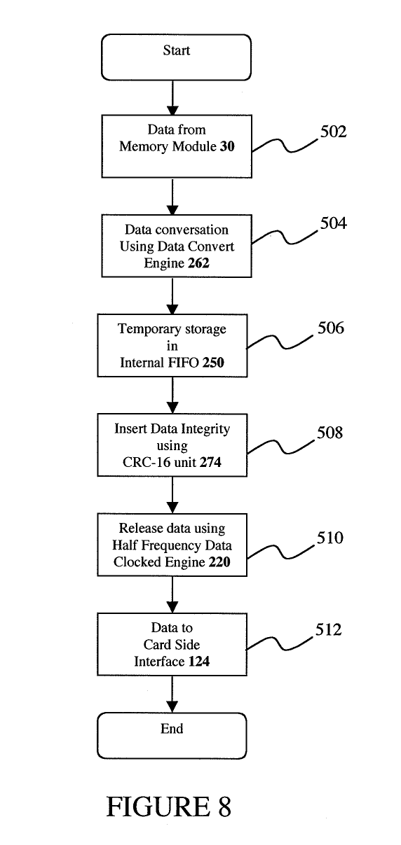

FIG. 8 illustrates the flow chart of the data flow when data is transferred from the SSC memory card 1 to the electronic device. In step 502, the data from the memory module 30 is transferred to the data convert engine 262. The data convert engine 262 then converts the data in step 504. The converted data in step 504 is temporarily stored in the internal FIFO 250 in step 506. In step 508, the CRC-16 unit 274 checks the integrity of the converted data before transferring the data to the half frequency data clocked engine 220 in step 512. Finally, the data is transferred to the card-side interface 124 in step 512.

Electronic devices configured in different formats do not have a standard physical interface. In order to connect the SSC memory card 1 to electronic devices using existing interfaces such as SD slot or MS slot, an adaptor unit (not shown) is used. Depending on the format that the electronic device is configured with, a suitable adaptor unit is chosen to mechanically couple the SSC memory card 1 to the electronic device.

While the present invention has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

What is claimed is:

1. A memory card for use with an electronic device, the memory card comprising:
an input/output (I/O) interface for coupling the memory card to the electronic device;
a card controller electrically coupled to the I/O interface, the card controller comprising:
a plurality of engines configured to operate in different formats;
format detecting means for detecting the format of the electronic device and generating a response signal indicating the format of the electronic device; and
a micro-controller electrically coupled to the plurality of engines and the format detecting means, wherein when the micro-controller receives the response signal, it activates an appropriate engine from the plurality of engines to transfer data based on the response signal; and
a memory module electrically coupled to the plurality of engines for storing data.

2. The memory card of claim 1, wherein the plurality of engines have a first engine operating at a predetermined system frequency, the first engine comprising:
a command module coupled to the micro-controller, wherein the command module is configured to transmit command packets to the electronic device or receive command packets from the electronic device; and
a data transfer module coupled to the micro-controller and the command module, wherein the micro-controller controls the data transfer module to transfer data packets between the memory module and the electronic device depending on the type of command packet received from the electronic device.

3. The memory card of claim 2, wherein the command module comprises:
a command encoder coupled to the micro-controller, wherein the command encoder is configured to encode a command signal from the micro-controller into a command packet that is to be transmitted to the electronic device; and
a command control engine coupled to the command encoder, wherein the command control engine is configured to control the format of the command packet that is transmitted to the electronic device;

4. The memory card of 3, wherein the command module further comprises a first cyclic redundancy check (CRC) unit coupled to the command control engine, wherein the first CRC unit is configured to protect the content of the command packet in order for the first engine to receive or transmit the command packet correctly.

5. The memory card of claim 2, wherein the data transfer module comprises:
a half frequency data clocked engine coupled to the micro-controller and the I/O interface, comprising:
a first internal clock and a second internal clock, wherein the frequency of both first and the second internal clock is half of the predetermined system frequency, wherein the second internal clock is configured to operate at a half-period delay relative to the first internal clock;
a positive data capture engine configured to capture data at the positive edge of the first internal clock and second internal clock;
a negative data capture engine configured to capture data at the negative edge of the first internal clock and second internal clock;
a data storage engine coupled to both the positive and negative data capture engines, comprising:
a positive data region configured to store the data captured by the positive data capture engine;
a negative data region configured to store the data captured by the negative data capture engine;
a first data pointer configured to locate the data stored in the positive data region; and
a second data pointer configured to locate the data stored in the negative data region;
wherein the data stored in both the positive and negative data regions are packed into a data packet;
a data multiplexer engine coupled to the data storage engine, wherein the data multiplexer engine is configured to receive the data packet from the data storage engine and then stores the data packet in the memory module; and
a data control engine coupled to the micro-controller, wherein the data control engine is configured to control the format of the data packet.

6. The memory card of claim 5, wherein the data transfer module further comprises an internal buffer coupled to the data multiplexer engine and the memory module, wherein the internal buffer serves as a temporary data storage for the data packet.

7. The memory card of claim 5, wherein the data transfer module further comprises a second CRC unit coupled to the data control engine, wherein the second CRC unit is configured to check the integrity of the data packet in order for the first engine to transmit or receive the data packet correctly.

8. The memory card of claim 6, wherein the data transfer module further comprises a data convert engine coupled to the micro-controller and I/O interface, wherein the data convert engine is configured to convert data packet in parallel format from the internal buffer to serial format for the I/O interface, and wherein the data convert engine is configured to convert data packet in serial format from the I/O interface to parallel format for the internal buffer.

9. The memory card of claim 1, wherein the plurality of engines configured to operate in different formats are selected from the group consisting of Secure Digital (SD), Serial Peripheral Interface (SPI), Memory Stick (MS) or Memory Stick Pro (MS Pro).

10. The memory card of claim 1 further comprises a card-side interface that serves as a mechanical connection between the I/O interface and the card controller.

11. The memory card of claim 10, wherein the card controller is coupled to the card-side interface via a serial to parallel interface, wherein the serial to parallel interface converts serial data format from the card-side interface to parallel data format for processing by the plurality of engines.

12. The memory card of claim 1, wherein the means for detecting the format of the electronic device can be a card mode and clock control unit.

13. The memory card of claim 1 further comprises a memory-side interface that serves as a mechanical connection between the card controller and the memory module.

14. The memory card of claim 13, wherein the card controller is coupled to the memory-side interface via a memory interface.

15. The memory card of claim 1, wherein the card controller further comprises a power on reset (POR) unit that resets the internal circuitry of the card controller when the memory card is first coupled to the electronic device.

16. The memory card of claim 1, wherein the card controller further comprises a regulator that converts supply voltage to a suitable voltage level for use by the internal circuitry of the card controller.

17. The memory card of claim 1, wherein the memory module can be a plurality of NAND Flash memory chips.

18. The memory card of claim 1, wherein the I/O interface can be coupled to the electronic device via an adaptor unit.
